(19) United States
(12) Patent Application Publication
(10) Pub. No.: US 2024/0273067 A1
(43) Pub. Date: Aug. 15, 2024

(54) INFORMATION PROCESSING APPARATUS, METHOD FOR CONTROLLING INFORMATION PROCESSING APPARATUS, AND STORAGE MEDIUM

(71) Applicant: CANON KABUSHIKI KAISHA, Tokyo (JP)

(72) Inventor: KEN TOKITA, Kanagawa (JP)

(21) Appl. No.: 18/433,203

(22) Filed: Feb. 5, 2024

(30) Foreign Application Priority Data
Feb. 9, 2023 (JP) 2023-018181

(51) Int. Cl. G06F 16/16; H04N 1/00

(52) U.S. Cl. CPC G06F 16/164; H04N 1/00244

(57) ABSTRACT

An information processing apparatus is configured to obtain image data by a single scan, analyze the image data to extract a character string, generate a plurality of files from the image data, and generate a filename of each of the plurality of files using a character string extracted from the image data included in the corresponding file of the plurality of files. In a case where at least two generated filenames among the generated filenames of the plurality of files are the same, add an identifier and determine filenames so that the at least two filenames are distinguished.

### BACKGROUND

### Field of the Disclosure

The present disclosure relates to a technique for giving divided files filenames.

### Description of the Related Art

Techniques for converting image data obtained by scanning a document or received facsimile data into a file have conventionally been widely used in information processing apparatuses, such as a multifunction peripheral (MFP). Techniques for transmitting the converted file to and storing the file in a storage server on a network have also been used. Techniques for dividing a plurality of pieces of scanned image data in numbers set in advance and converting the divided pieces of image data into files have also been known. For example, Japanese Patent Application Laid-Open No. 2005-217624 discusses a technique for dividing a plurality of pieces of scanned image data in numbers set in advance and converting the divided pieces of image data into files. In Japanese Patent Application Laid-Open No. 2005-217624, different numbers are attached to a character string common to the filenames of the plurality of divided files in order and the filenames of the respective files are determined.

However, Japanese Patent Application Laid-Open No. 2005-217624 does not take into account the condition under which the filenames of the respective divided files are numbered.

### SUMMARY

Aspects of the present disclosure are directed to, in generating a plurality of files from image data obtained by a single scan, generating filenames in consideration of a condition under which the filenames of the respective files are numbered.

According to an aspect of the present disclosure, an information processing apparatus includes at least one memory configured to store instructions, and at least one processor communicatively connected to the at least one memory and configured to execute the stored instructions to obtain image data by a single scan, analyze the image data to extract a character string, generate a plurality of files from the image data, automatically generate a filename of each of the plurality of files using a character string extracted from the image data included in a corresponding file of the plurality of files, and in a case where at least two generated filenames among the generated filenames of the plurality of files are the same, add an identifier and determine filenames so that the at least two same filenames are distinguished.

Further features of the present disclosure will become apparent from the following description of embodiments with reference to the attached drawings.

### BRIEF DESCRIPTION OF THE DRAWINGS

FIG. 1 is a diagram illustrating an overall configuration of an information processing system.

FIG. 2 is a block diagram illustrating a hardware configuration of a multifunction peripheral (MFP).

FIG. 3 is a block diagram illustrating a hardware configuration of an MFP link server and a storage server.

FIG. 4 is a block diagram illustrating a software configuration of the information processing system.

FIG. 5 is a diagram illustrating an example of a template selection screen.

FIG. 6 is a diagram illustrating an example of a profile execution screen.

FIG. 7 is a diagram illustrating an example of a file naming rule setting screen.

FIG. 8 is a diagram illustrating an example of the file naming rule setting screen.

FIG. 9 is a diagram illustrating an example of the file naming rule setting screen.

FIG. 10 is a diagram illustrating an example of a scan setting screen.

FIG. 11 is a diagram illustrating an example of a scanned file list screen.

FIG. 12 is a flowchart illustrating details of scanned file list screen display processing.

FIGS. 13A and 13B are flowcharts illustrating details of filename generation processing.

FIG. 14 is a diagram illustrating an example of the file naming rule setting screen.

FIG. 15 is a diagram illustrating an example of the file naming rule setting screen.

### DESCRIPTION OF THE EMBODIMENTS

Exemplary embodiments of the present disclosure will be described below with reference to the drawings. The following embodiments are not intended to limit the disclosure set forth in the claims, and all combinations of features described in the embodiments are not necessarily essential to the solving means of the disclosure.

### <System Configuration>

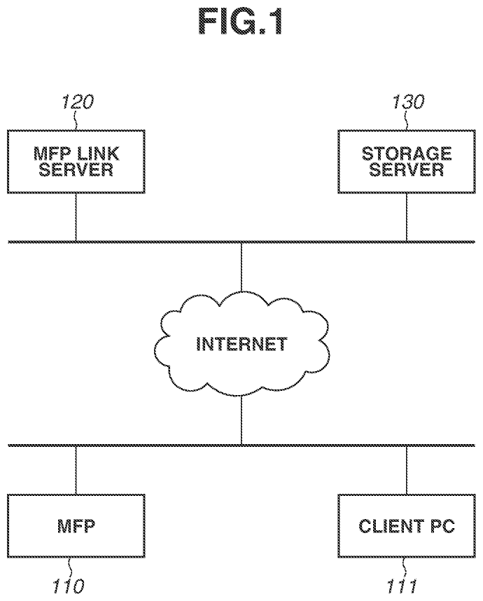

A first embodiment of the present disclosure will be described below. FIG. 1 is a diagram illustrating an overall configuration of an information processing system according to the first embodiment. The information processing system includes a multifunction peripheral (MFP) 110, a client personal computer (PC) 111, and server apparatuses 120 and 130 providing cloud services on the Internet. The MFP 110 and the client PC 111 are communicably connected to various devices providing various services on the Internet via a local area network (LAN).

The MFP 110 is an example of an image processing apparatus that has a scan function. The MFP 110 has a plurality of functions, such as a print function and a box storage function, in addition to the scan function. The client PC 111 is an information processing apparatus that can be provided with cloud services via the Internet. Examples of the client PC 111 include a desktop terminal and a mobile terminal. The server apparatuses 120 and 130 are both information processing apparatuses that provide cloud services. The server apparatus 120 according to the present embodiment provides a cloud service for performing image analysis on a scanned image received from the MFP 110 and transferring a request from the MFP 110 to the server apparatus 130 providing another service. The cloud service provided by the server apparatus 120 will hereinafter be referred to as an “MFP link service”. The server apparatus 130 provides a cloud service for storing file data transmitted via the Internet into a predetermined folder and providing a stored file in response to a request from a web browser on the client PC 111. Such a cloud service will hereinafter be referred to as a “storage service”.

In the present embodiment, the server apparatus 120 providing the MFP link service will be referred to as an “MFP link server”. The server apparatus 130 providing the storage service will be referred to as a “storage server”.

While the information processing system according to the present embodiment includes the MFP 110, the client PC 111, the MFP link server 120, and the storage server 130, the system configuration is not limited thereto. For example, the MFP 110 may also serve as the client PC 111 and/or the MFP link server 120. The MFP link server 120 may be located on the LAN instead of the Internet. The storage server 130 may be replaced with a mail server and applied to situations where a scanned document image is transmitted as attached to an email.

### <Hardware Configuration of MFP 110>

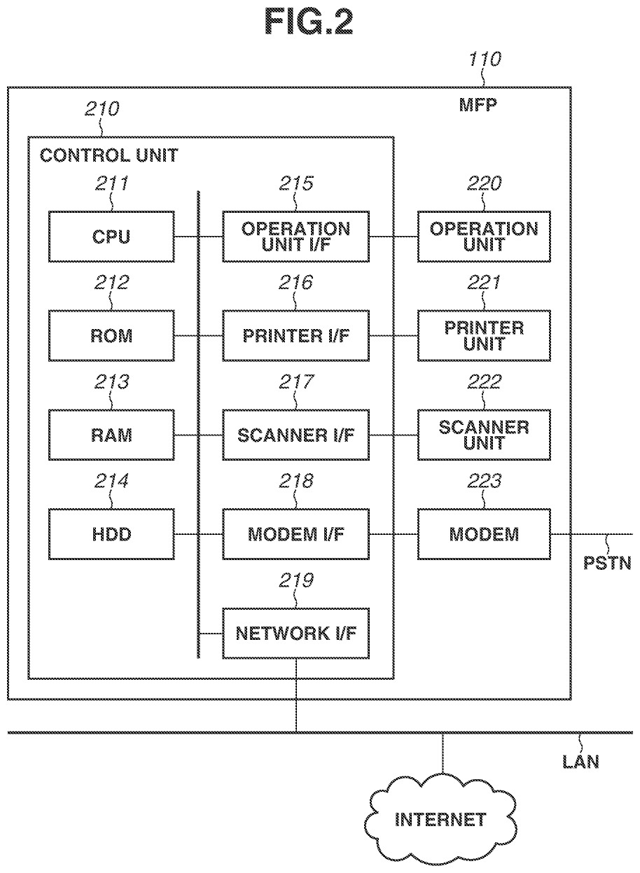

FIG. 2 is a block diagram illustrating a hardware configuration of the MFP 110. The MFP 110 includes a control unit 210, an operation unit 220, a printer unit 221, a scanner unit 222, and a modem 223. The control unit 210 includes components 211 to 219 to be described below, and controls the operation of the entire MFP 110. A central processing unit (CPU) 211 reads control programs (programs corresponding to various functions illustrated in a software configuration diagram to be described below) stored in a read-only memory (ROM) 212 and executes the control programs. A random access memory (RAM) 213 is used as a temporary storage area, such as a main memory and a work area of the CPU 211. In the present embodiment, one CPU 211 is described to perform processes illustrated in flowcharts to be described below using one memory (RAM 213 or hard disk drive [HDD] 214). However, this is not restrictive. For example, a plurality of CPUs and a plurality of RAMs or HDDs may cooperate to perform the processes.

The HDD 214 is a mass storage unit storing image data and various programs. An operation unit interface (I/F) 215 is an I/F that connects the operation unit 220 and the control unit 210. The operation unit 220 includes a touchscreen and a keyboard, and accepts a user's operation, input, and instructions. Touch operations on the touchscreen include ones with a human finger and ones with a touch pen. A printer I/F 216 is an I/F that connects the printer unit 221 and the control unit 210. Print image data is transferred from the control unit 210 to the printer unit 221 via the printer I/F 216, and printed on a recording medium.

A scanner I/F 217 is an I/F that connects the scanner unit 222 and the control unit 210. The scanner unit 222 reads a document set on a not-illustrated platen glass or auto document feeder (ADF), generates scanned image data, and inputs the scanned image data to the control unit 210 via the scanner I/F 217. The scanned image data generated by the scanner unit 222 is printable by the printer unit 221 (copy output), stored in the HDD 214, and/or transmitted as a file or email to an external apparatus, such as the MFP link server 120 via the LAN. A modem I/F 218 is an I/F that connects the modem 223 and the control unit 210. The modem 223 communicates image data with a facsimile apparatus (not illustrated) on the public switched telephone network (PSTN) by facsimile. A network I/F 219 is an I/F that connects the control unit 210 (MFP 110) with the LAN. The MFP 110 transmits image data and information to various services on the Internet and receives various types of information using the network I/F 219. The hardware configuration of the MFP 110 described above is just an example. Other components may be included as appropriate. Some of the components may be omitted.

### <Hardware Configuration of Client PC and Server Apparatuses>

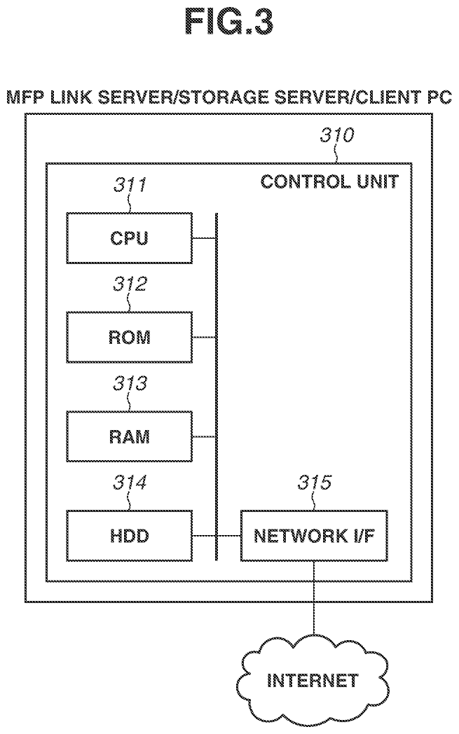

FIG. 3 is a block diagram illustrating a hardware configuration of the client PC 111, the MFP link server 120, and the storage server 130. The client PC 111, the MFP link server 120, and the storage server 130 each include a CPU 311, a ROM 312, a RAM 313, an HDD 314, and a network I/F 315. The CPU 311 controls overall operation by reading a control program stored in the ROM 312 and performing various types of processing. The RAM 313 is used as a temporary storage area, such as a main memory and a work area of the CPU 311. The HDD 314 is a mass storage unit storing image data and various programs. The network I/F 315 is an I/F that connects the client PC 111, the

MFP link server 120, or the storage server 130 with the Internet. The MFP link server 120 and the storage server 130 accept requests for various types of processing from other devices (such as the MFP 110 and the client PC 111) via the network I/F 315, and return processing results corresponding to the requests.

### <Software Configuration of Information Processing System>

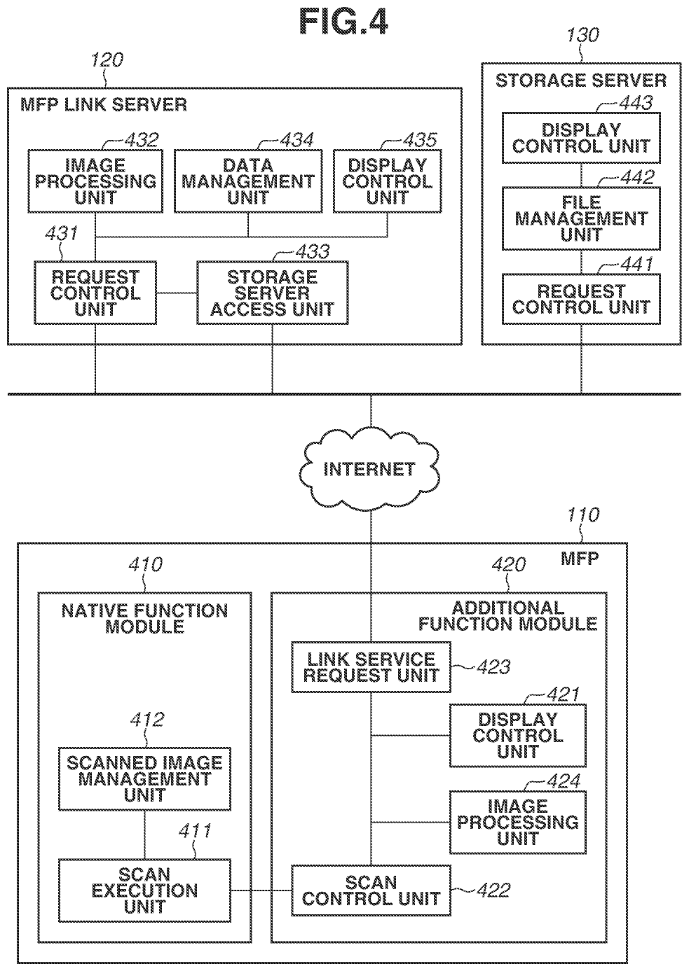

FIG. 4 is a block diagram illustrating a software configuration of the information processing system according to the present embodiment. Software configurations corresponding to the respective roles of the MFP 110, the MFP link server 120, and the storage server 130 will be described below in order. The following description focuses on functions related to processing for converting a scanned image obtained by the MFP 110 scanning a document into a file and storing the file into the storage server 130 via the MFP link server 120 among various functions of the apparatuses.

### <Software Configuration of MFP>

The MFP 110 is broadly divided into two functional modules: a native function module 410 and an additional function module 420. The native function module 410 is a standard application of the MFP 110. The additional function module 420 is an application additionally installed on the MFP 110. The additional function module 420 is a Java (registered trademark) based application and can easily add functions to the MFP 110. Other not-illustrated additional applications may be installed on the MFP 110.

The native function module 410 includes a scan execution unit 411 and a scanned image management unit 412. The additional function module 420 includes a display control unit 421, a scan control unit 422, a link service request unit 423, and an image processing unit 424.

The display control unit 421 displays a user interface (UI) screen for accepting various user operations on the touchscreen of the operation unit 220. Examples of the various user operations include input of login authentication information for accessing the MFP link server 120, scan settings, setting of rules related to folder sorting and file naming, a scan start instruction, and a file storage instruction.

The scan control unit 422 issues an instruction to execute scan processing to the scan execution unit 411 along with scan setting information, based on user operations made on the UI screen (e.g., pressing of a “start scan” button). Based on the instruction to execute the scan processing from the scan control unit 422, the scan execution unit 411 causes the scanner unit 240 to perform a document reading operation via the scanner I/F 217, and generates scanned image data. The generated scanned image data is stored in the HDD 214 by the scanned image management unit 412. Here, information about a scanned image identifier uniquely identifying the stored scanned image data is notified to the scan control unit 422. Examples of the scanned image identifier include numbers, symbols, and alphabetical letters for uniquely identifying the image scanned by the MFP 110. For example, the scan control unit 422 acquires the scanned image data to be converted into a file from the scanned image management unit 412 using the foregoing scanned image identifier. The scan control unit 422 then instructs the link service request unit 423 to request file conversion processing from the MFP link server 120.

The link service request unit 423 requests various types of processing and receives responses from the MFP link server 120. Examples of the various types of processing include login authentication, an analysis of a scanned image, and transmission of scanned image data. Communication protocols such as Representational State Transfer (REST) and the Simple Object Access Protocol (SOAP) are used for interaction with the MFP link server 120.

The image processing unit 424 performs predetermined image processing on the scanned image data and generates attributes, including a filename, to be used for the UI screen displayed on the display control unit 421.

### <Software Configuration of Server Apparatuses>

The software configuration of the MFP link server 120 will initially be described. The MFP link server 120 includes a request control unit 431, an image processing unit 432, a storage server access unit 433, a data management unit 434, and a display control unit 435. The request control unit 431 waits in a state capable of receiving a request from an external apparatus, and instructs the image processing unit 432, the storage server access unit 433, and the data management unit 434 to perform predetermined processing based on the received request. The image processing unit 432 performs image analysis processing such as text area detection processing, character recognition processing, and similar document determination processing, as well as image editing processing, such as rotation and tilt correction, on the scanned image data transmitted from the MFP 110. The storage server access unit 433 issues processing requests to the storage server 130. The cloud service publishes various I/Fs for storing files and acquiring stored files into/from the storage server 130 using protocols such as REST and SOAP. The storage server access unit 433 issues the requests to the storage server 130 using the published I/Fs. The data management unit 434 stores and manages user information and various types of setting data for the MFP link server 120 to manage. The display control unit 435 receives a request from a web browser running on the MFP 110 or the client PC 111 connected via the Internet, and returns screen configuration information (such as Hypertext Markup Language [HTML] and Cascading Style Sheets [CSS]) for screen display. The user can check registered user information and change scan settings and rule settings related to folder sorting and file naming via the screen displayed on the web browser.

Next, the software configuration of the storage server 130 will be described. The storage server 130 includes a request control unit 441, a file management unit 442, and a display control unit 443. The request control unit 441 waits in a state capable of receiving a request from an external apparatus. In the present embodiment, the request control unit 441 instructs the file management unit 442 to store a received file or read a stored file based on a request from the MFP link server 120. The request control unit 441 then returns a response corresponding to the request to the MFP link server 120. The display control unit 443 receives a request from the web browser running on the MFP 110 or the client PC 111 connected via the Internet, and returns screen configuration information (such as HTML and CSS) for screen display. The user can check and acquire stored files via the screen displayed on the web browser.

Although omitted in FIG. 4, the client PC 111 includes a functional module similar to the foregoing additional function module 420.

### <Scan Profile>

The “setting of a file naming rule” to be described below is performable for each of various scan workflows. As employed herein, a scan workflow refers to a workflow for transmitting data of a scanned image obtained by scanning a document such as a business form to a specific transmission destination (such as the storage server 130) under a specific condition. The information about the condition and the transmission destination of each scan workflow is managed using a scan profile. The user can easily implement a predetermined scan workflow by creating a scan profile in advance.

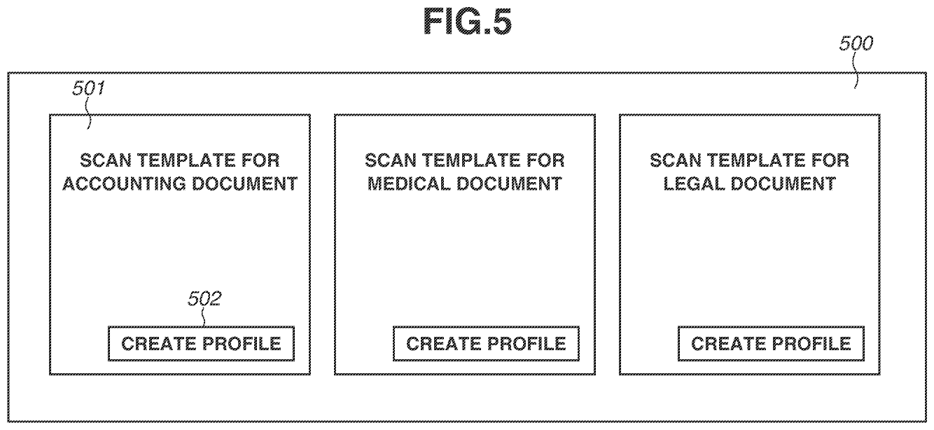

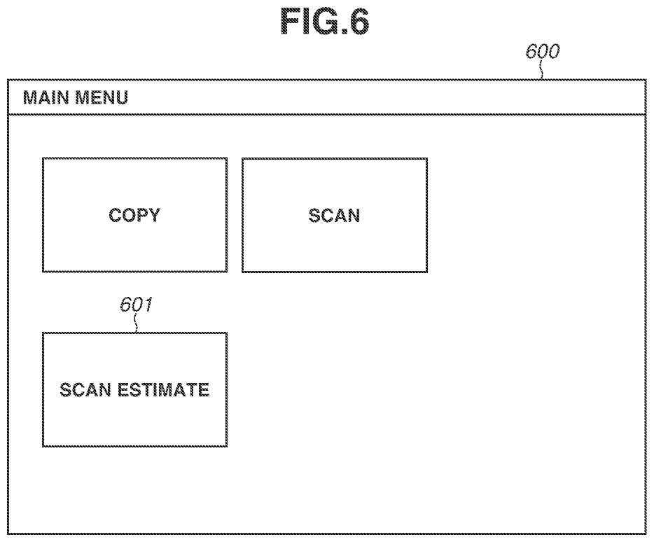

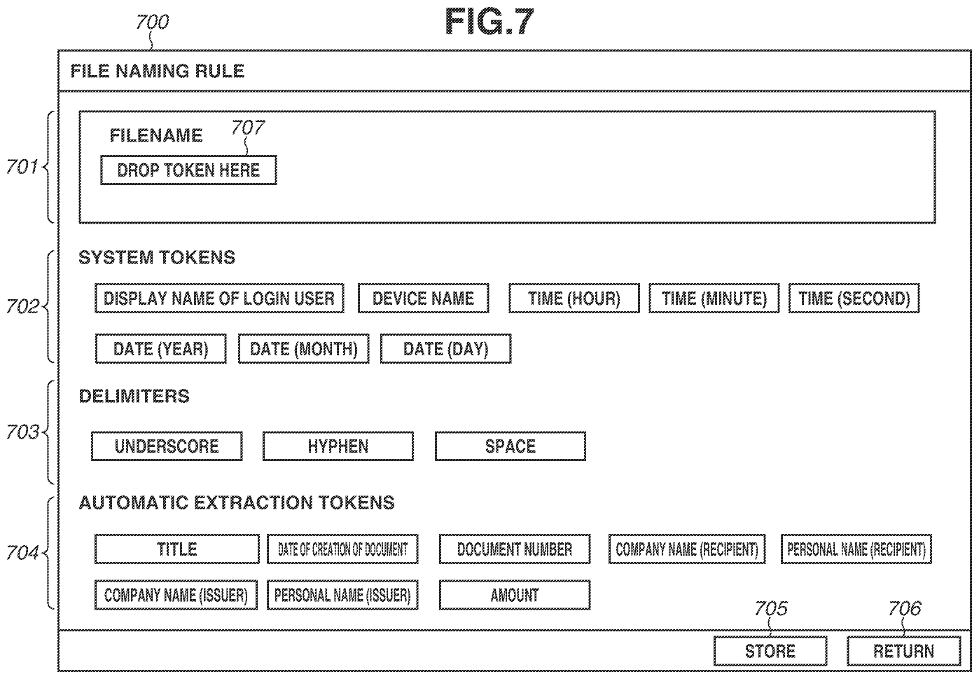

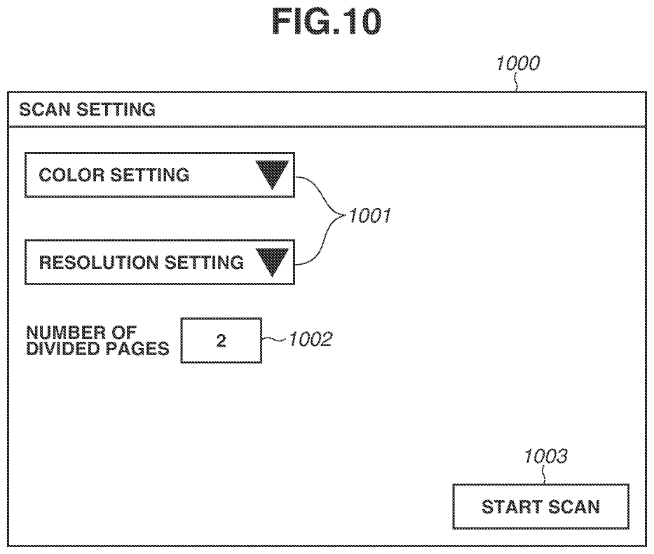

A method for creating a scan profile will be described. The user can log in to the MFP link server 120 via the client PC 111, for example, and display a UI screen illustrated in FIG. 5 through screen transition from a main screen (not illustrated) displayed after the login. FIG. 5 illustrates an example of a UI screen that lists templates for creating a scan profile (hereinafter, referred to as a “template selection screen”), displayed on the operation unit 220 of the client PC 111. This template selection screen 500 displays templates 501 displayed on a profile creation template selection screen (not illustrated). The templates 501 may be prepared for respective use cases, for respective types and fields of work, or for respective storage servers. Alternatively, the user may create a profile by customizing all settings without using a template. If a “create profile” button 502 is pressed, a scan profile setting screen (not illustrated) is displayed. Workflow settings, such as the type of transmission destination storage server, the type of output file, and a folder sorting rule and a file naming rule to be set as described below are performable on the scan profile setting screen. A screen for setting a file naming rule will be described below with reference to FIGS. 7 to 9. If the user makes all the settings and presses a “store” button (not illustrated) on the scan profile setting screen, a scan profile is created. The created scan profile is displayed on a profile execution screen 600 of the MFP 110 as illustrated in FIG. 6. If a profile 601 is selected, a scan setting screen 1000 of FIG. 10 is displayed. The scan setting screen 1000 includes a scan setting group 1001, a page division setting 1002, and a start scan button 1003. The scan setting group 1001 can set a color mode and resolution for reading a document, for example. The page division setting 1002 is a setting for dividing documents scanned at a time into files. In the present embodiment, a setting for dividing the documents into files in specified numbers of pages is illustrated. If the number of pages is set to “2” as illustrated in the diagram and 10 pages of documents are scanned at a time, the documents are divided in two pages to generate five divided files. The group of files then can be transmitted to the storage server 103 based on settings. The division setting is not limited to “division by the number of pages”. If barcodes, such as a Quick Response (QR) code (registered trademark), are printed on documents, the documents may be divided with the recognized barcodes as boundary positions. If documents are interleaved with sheets such as white sheets, the documents may be divided with the recognized white sheets as boundary positions.

### <Setting of File Naming Rule>

Next, the setting of a naming rule related to filenames to be given in converting scanned images into files will be described. In the present embodiment, the file naming rule will be described to be set by the client PC 111. FIG. 7 is a diagram illustrating an example of a UI screen for the user to set a file naming rule (hereinafter, referred to as a “file naming rule setting screen”), displayed on a display (not illustrated) of the client PC 111. FIG. 7 illustrates one of items settable on the scan profile setting screen (not illustrated). A file naming rule setting screen 700 illustrated in FIG. 7 is in an initial display state. The file naming rule setting screen 700 includes four areas, namely, a rule editing area 701, a system token area 702, a delimiter token area 703, and an automatic extraction token area 704. The rule editing area 701 includes a token drop area 707. There is a “store” button 705 for checking and storing a set file naming rule at the bottom of the file naming rule setting screen 700.

As employed herein, a “token” refers to a unit item for the user to specify a character string (including a symbol or symbols) to be used in property information (e.g., filename), taking into consideration the attributes of the character string. The property information is to be used in storing a file in the storage server 130. Tokens include general tokens (general items) and special tokens (special items). The general tokens correspond to character strings of predetermined attributes. The special tokens are intended to automatically extract character strings corresponding to their attribute types from documents. System tokens and delimiter tokens to be described below are general tokens.

Automatic extraction tokens to be described below are special tokens. On various setting screens to be described below, the tokens are expressed as UI elements to be subjected to user operations, such as a drag operation and a drop operation.

The system token area 702, the delimiter token area 703, and the automatic extraction token area 704 list various tokens. The rule editing area 701 displays a file naming rule created by using various tokens. As employed herein, a file naming rule includes information about the filename of scanned data and is set by the user in advance.

### <Setting of Tokens>

The user can select one of the tokens displayed in the system token area 702, the delimiter token area 703, and the automatic extraction token area 704 with a drag operation, and drop the selected token to the token drop area 707. As a result, a new filename including the character string corresponding to the token selected by the drag operation is displayed in a pseudo manner.

The system token area 702 is an area displaying tokens of which attribute values are the user's environment variables. Examples of the tokens include “display name of login user”, “time”, and “date”. Other examples of the tokens include “device location”, “device name”, and “serial number of device”. The “time” token may be subdivided into “time (hour)”, “time (minute)”, and “time (second)”. The “date” token may be subdivided into “date (year in four digits)”, “date (year in two digits)”, “date (month)”, and “date (day)”.

The delimiter token area 703 is an area displaying tokens of which attribute values are delimiters (symbols). Examples include “underscore” and “hyphen”. The automatic extraction token area 704 is an area displaying tokens of which attribute values are character strings corresponding to their attribute types among character strings extracted by analyzing scanned images. Examples of processing for analyzing a scanned image may include optical character recognition (OCR) processing and processing for decoding a barcode or QR code and extracting a character string. As illustrated in FIGS. 7 to 9, examples of the automatic extraction tokens include “title”, “date of creation of document”, “document number”, “company name (recipient)”, “personal name (recipient)”, “company name (issuer)”, “personal name (issuer)”, and “amount”.

Moreover, the user can specify a region in a scanned image to add an automatic extraction token. In such a case, a character string obtained by OCR processing of the user-specified region serves as the attribute value of the token. Other examples of the automatic extraction tokens may include “barcode value” and “QR code value”. A character string obtained by decoding a barcode or a QR code serves as the attribute value of the token.

If the “store” button 705 is pressed, the information about the file naming rule displayed in the rule editing area 701 is transmitted to the MFP link server 120 and managed by the data management unit 434. If a “return” button 706 is pressed, the file naming rule displayed in the rule editing area 701 is discarded and the setting processing ends.

The file naming rule according to the present embodiment will be described. The combination and order of tokens settable as a file naming rule are not limited in particular. For example, a file naming rule including only delimiters of the delimiter token area 703 can be created. A file naming rule consisting only of the same system tokens can be created.

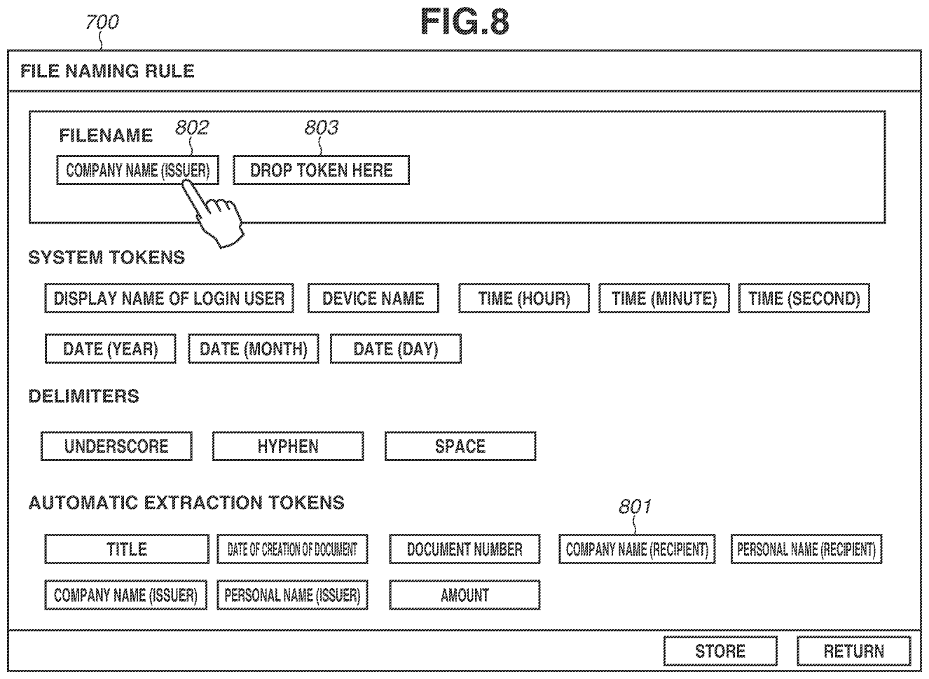

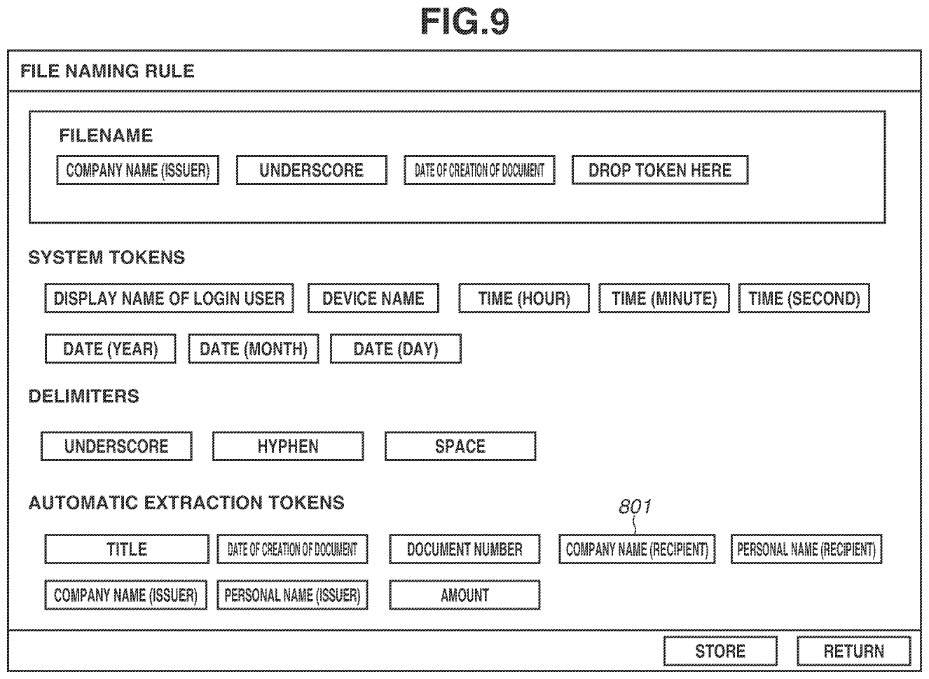

Next, a method for setting a file naming rule will be described with reference to FIGS. 8 and 9. FIG. 8 illustrates a state of the file naming rule setting screen 700 where the user drags and drops an automatic extraction token in the automatic extraction token area 704 to the rule editing area 701. Specifically, FIG. 8 illustrates a state where an automatic extraction token 801 having an attribute name “company name (issuer)” among the plurality of automatic extraction tokens displayed in the automatic extraction token area 704 is dropped to the token drop area 707. In the rule editing area 701 of FIG. 8, a new token 802 having the attribute name “company name (issuer)” is located at the position of the token drop area 707 to which the user has made the drop operation, and a new token drop area 803 is generated. If, in the state illustrated in FIG. 8, a token is selected from the token groups in the foregoing various token areas 702 to 704 and dragged and dropped to the token drop area 803, another new token drop area is generated (not illustrated). If a token is further dragged and dropped to the new token drop area generated, another token drop area is generated. FIG. 9 illustrates the state of the file naming rule setting screen 700 after repetition of such operations. In the rule editing area 701 of FIG. 9, two new tokens, namely, one having an attribute name “underscore” and one having an attribute name “date of creation of document” are added, and another token drop area is generated. In other words, the file naming rule set on the file naming rule setting screen 700 of FIG. 9 is “{company name (issuer)}_{date of creation of document}”.

The tokens set in the rule editing area 701 as described above can be rearranged by drag operations. For example, adjoining tokens can be replaced with each other. Another token can be inserted between tokens.

### <Deletion of Token>

Next, a case where the user deletes a folder level-specific token set as described above will be described. If the user hovers the mouse over one of the tokens displayed in the rule editing area 701, an “x” button is displayed on the token (not illustrated).

The user can delete a token by pressing such an “x” button.

### <Scanned File List Screen>

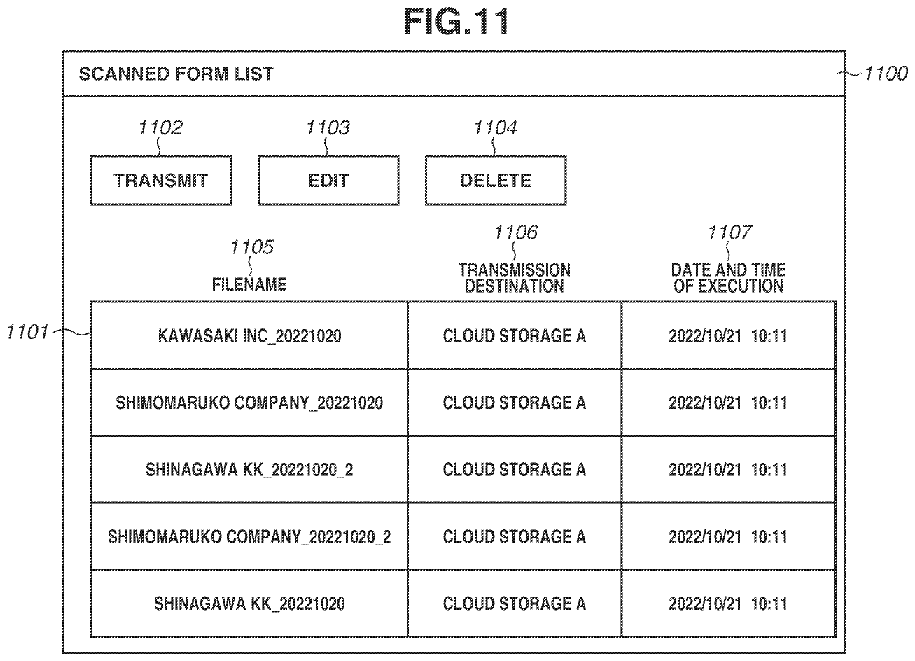

FIG. 11 is a diagram illustrating an example of a screen displayed by the MFP 110 or the client PC 111. FIG. 11 is a diagram illustrating an example of a scanned file list screen 1100. A list of files of which scanning and image analysis processing are completed and that are yet to be transmitted to the storage server 130 is browsable on this screen. The scanned file list screen 1100 includes a scanned file list 1101, a transmission button 1102, an edit button 1103, and a delete button 1104. The scanned file list 1101 is a list displaying the files of which scanning and the generation of a filename (to be described below) are completed. This list includes a filename 1105, a transmission destination 1106, and a date and time of execution 1107. The filename 1105 is a column that lists identifiers uniquely identifying the names of the files. The transmission destination column 1106 is a column that lists the names of storage servers 130 to transmit the files to. The folder paths (not illustrated) on the cloud storages to transmit the files to may be displayed. The transmission button 1102 is a button for transmitting the files to the storage servers 130. If a file is selected from the scanned file list 1101 and the transmission button 1102 is pressed, the file is transmitted to the storage server 130 displayed in the transmission destination 1106. If the transmission is normally completed, the file is deleted from the list.

The edit button 1103 is a button for editing the filename 1105. If a file is selected from the scanned file list 1101 and the edit button 1103 is pressed, the filename of the selected file can be edited. The delete button 1104 is a button for deleting a file. If a file is selected from the scanned file list 1101 and the delete button 1104 is pressed, the selected file can be deleted.

### <Procedure for Generating Filename>

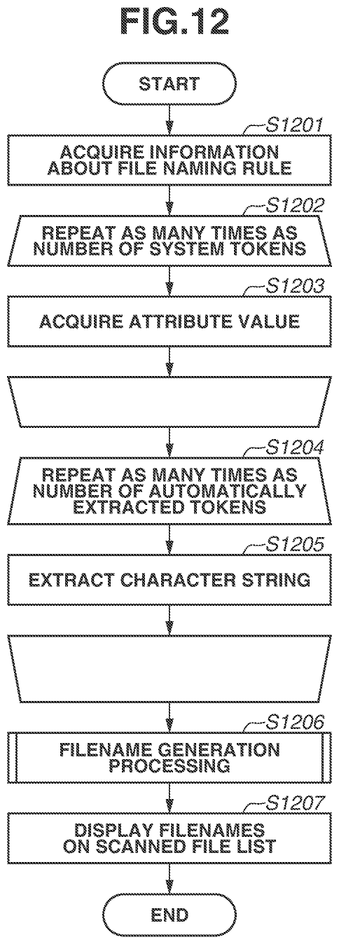

FIG. 12 is a flowchart illustrating a processing procedure for displaying divided scanned files on the foregoing scanned file list screen 1100 on the client PC 111. The execution of this procedure is triggered by scanning 10 pages of documents with the number of divided pages set to “2”. This procedure is intended for one of the divided files, and performed on each of the divided files. In the present embodiment, the order of files for the procedure to be performed on is the same as the order of acquisition of the data included in the divided files.

Suppose that the file naming rule is the following:
<Setting Details of File Naming Rule>
“‘company name (issuer) (automatic extraction token)’ ‘underscore (delimiter token)’ ‘date of creation of document (automatic extraction token)’”.
Details are now described with reference to the flowchart of FIG. 12.

In step S1201, the image processing unit 424 acquires information about the file naming rule set by the user. In steps S1202 and S1203, processing for acquiring the attribute value of a system token is repeated as many times as the number of system tokens included in the information acquired in step S1201. In step S1203, the image processing unit 424 acquires from the data management unit 434 a character string corresponding to the user's environment variable corresponding to the system token. For example, character strings expressing the scanning date “2020”, “2”, and “27” are acquired for system tokens “year”, “month”, and “day”, respectively. In the foregoing example, the file naming rule does not include a system token, and such processing is omitted. If no system token is included in the acquired file naming rule, the processing skips the operations in steps S1202 and S1203 and proceeds to step S1204. Unlike automatic extraction tokens and delimiter tokens, the attribute values of the system tokens vary depending on system settings. The character strings (attribute values) corresponding to the respective system tokens are therefore desirably updated each time the system settings are changed.

In steps S1204 and S1205, processing for acquiring the attribute value of an automatic extraction token is repeated as many times as the number of automatic extraction tokens included in the information acquired in step S1201. In step S1205, the image processing unit 424 performs automatic extraction processing to extract a character string corresponding to the attribute type corresponding to the automatic extraction token from the scanned image. The automatic extraction processing is not limited in particular. For example, a character string is identified using a trained model that is trained with a large number of test images and character string areas of respective corresponding attribute types by machine learning. For example, character strings “KAWASAKI INC” and “20221020” are extracted from the scanned image for the automatic extraction tokens “company name (issuer)” and “date of creation of document”, respectively, using the trained model. If an automatic extraction token is a user-specified region in the scanned image, a character string is identified from the result of the OCR processing of the region. If an automatic extraction token is a barcode, the barcode is decoded to extract a character string. In the foregoing example, the file naming rule includes two automatic extraction tokens, and the acquisition of the attribute value is repeated twice. If no automatic extraction token is included in the acquired file naming rule, the processing skips the operations in steps S1204 and S1205 and proceeds to step S1206.

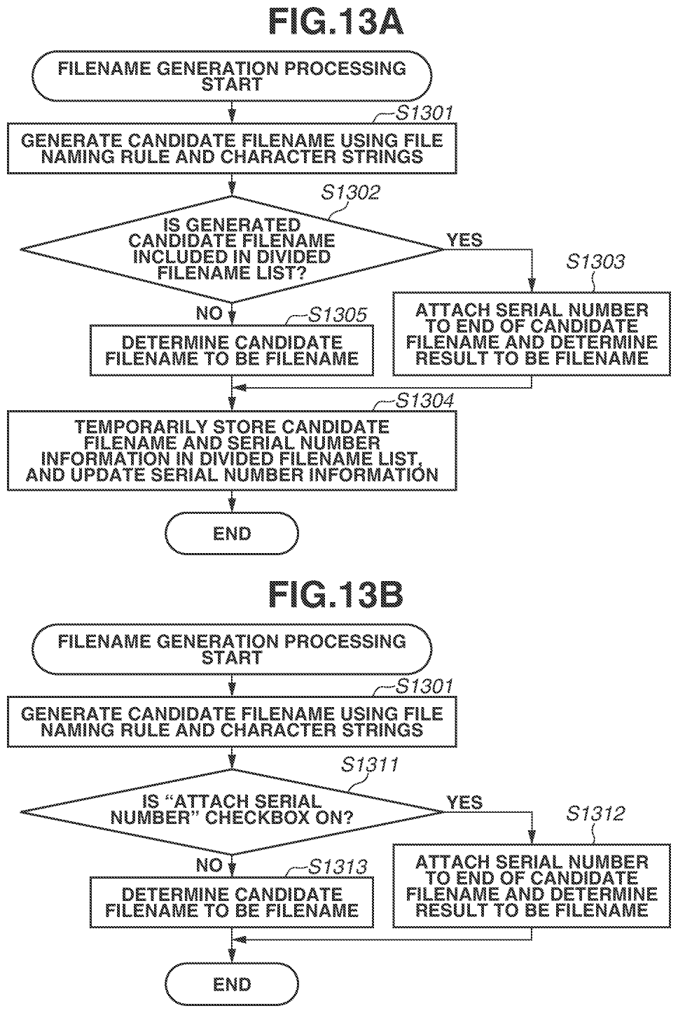

In step S1206, the image processing unit 424 generates a filename. The procedure for generating the filename will be described in detail below with reference to FIG. 13A. In step S1207, the image processing unit 424 transmits file attributes including the generated filename to the display control unit 421. The display control unit 421 displays the file attributes on the scanned file list 1101 of the foregoing scanned file list screen 1100.

In the present embodiment, the file attributes of the file generated by scanning are displayed on the scanned file list screen 1100. However, the file generated by scanning and the generated filename may be simply transmitted to the storage server 130 without displaying the scanned file list screen 1100.

FIG. 13A is a flowchart illustrating a processing procedure for generating a filename.

In step S1301, the image processing unit 424 generates a candidate filename by using the acquired file naming rule, the character string of each system token acquired in step S1203, and the character string of each automatic extraction token acquired in step

S1205. For delimiter tokens, corresponding delimiters such as a period and a space are inserted. If no character string corresponding to the relevant automatic extraction token is extracted in step S1205, the name of the relevant automatic extraction token is used as a folder name, such as “{title}”. Similarly, for a manual extraction token, the set attribute name may be displayed, as with “{item 1}”.

In step S1302, the image processing unit 424 determines whether the generated candidate filename is included in a temporarily stored divided filename list. In other words, the image processing unit 424 determines whether the candidate filename agrees with a filename included in the temporarily stored divided filename list. The divided filename list is a list of sets of candidate filenames, which are generated based on the file naming rule, of divided files obtained by a single scan and the latest serial number information applied to the respective candidate filenames. In step S1302, if the image processing unit 424 determines that the generated candidate filename is not included in the divided filename list (NO in step S1302), the processing proceeds to step S1305. In step S1305, the image processing unit 424 determines the generated candidate filename to be the filename. In step S1304, the image processing unit 424 temporarily stores the candidate filename and serial number information “1” as a set into the divided filename list. If, in step S1302, the image processing unit 424 determines that the generated candidate filename is included in the divided filename list (YES in step S1302), the processing proceeds to step S1303. In step S1303, the image processing unit 424 acquires the latest serial number information about the candidate filename from the divided filename list. The image processing unit 424 then attaches the value of the latest serial number information incremented by one to the end of the candidate filename as a serial number and determines the result as the proper filename. The serial number is attached to avoid redundant filenames. For example, if there are the same candidate filenames and the temporarily stored serial number information is “1”, “_2” is attached to the end of the generated candidate filename. In step S1304, the image processing unit 424 updates the serial number information linked with the candidate filename. In the present embodiment, attaching a serial number refers to attaching an underscore “_” followed by the serial number to the end of the candidate filename. Other symbols, such as a hyphen “-”, may be used instead of the underscore “_”. The serial number may be directly attached to the end of the candidate without using a symbol. In the present embodiment, serial numbers refer to numbers by which filenames can be distinguished. In the example of FIG. 11 to be described below, there are generated filenames “KAWASAKI INC_20221020” and “KAWASAKI INC_20221020_2”. In other words, there is no filename “KAWASAKI INC_20221020” with “_1” attached. More specifically, the serial numbers are not attached in a consecutive manner like “_1” and “_2”. In the present embodiment, consecutive numbers thus do not necessarily need to be attached to the filenames, and numbers by which filenames can be distinguished are attached if the filenames are the same. Note that if filenames are the same, “_1” may be attached to the first one so that consecutive numbers like “_1” and “_2” are attached. The suffixes to be attached are not limited to numerals, and alphabetical letters may be attached in order.

The foregoing procedure will be described by using FIG. 11 as an example. In step S1301, a candidate filename “KAWASAKI INC_20221020” is generated for the first file. In step S1302, the image processing unit 424 determines that the temporarily stored divided filename list is empty (NO in step S1302). In step S1304, the candidate filename and serial number information “1” are temporarily stored into the divided filename list as a set. The candidate filename is then determined to be the proper filename of the first file. For the second file, a candidate filename “SHIMOMARUKO COMPANY” is generated in step S1301. In step S1302, the image processing unit 424 determines that

“SHIMOMARUKO COMPANY” is not included in the divided filename list (NO in step

S1304). In step S1304, the candidate filename and serial number information “1” are temporarily stored into the divided filename list as a set. The candidate filename is then determined to be the proper filename of the second file. For the third file, a candidate filename “KAWASAKI INC_20221020” is generated in step S1301. In step S1302, the image processing unit 424 determines that “KAWASAKI INC_20221020” is included in the divided filename list (YES in step S1302). In step S1303, the serial number information “1” linked with the candidate filename is acquired from the divided filename list. The value of the serial number information incremented by one, “2”, is then attached to the end of the candidate filename as a serial number. The resulting “KAWASAKI INC_20221020_2” is determined to be the filename of the third file. In step S1304, the serial number information linked with the candidate filename in the divided filename list is then updated to “2”. For the fourth file, a candidate filename “SHIMOMARUKO COMPANY_20221020” is generated in step S1301. In step S1302, “SHIMOMARUKO COMPANY_20221020” is determined to be included in the divided filename list (YES in step S1302). In step S1303, the serial number information linked with the candidate filename, “1”, is acquired from the divided filename list. The value of the serial number information incremented by one, “2”, is then attached to the end of the candidate filename as a serial number. The resulting “SHIMOMARUKO COMPANY_20221020_2” is determined to be the filename of the fourth file. In step S1304, the serial number information linked with the candidate filename in the divided filename list is then updated to “2”.

Through such processing, the filenames can be determined using the character strings corresponding to the data included in the respective files while appropriately attaching serial numbers to the divided files.

In the present embodiment, the procedure illustrated in FIG. 12 is described to be repeated on each divided file. However, this is not restrictive. For example, in step S1201, the file naming rule may be acquired only once for the first time, since the file naming rule is common to all divided files. The operations in steps S1202 to S1207 then may be repeated on each file. Alternatively, the operations in steps S1202 to S1206 may be repeated on each file, and then the information about all the divided files may be displayed on the scanned file list screen 1100 at a time.

A second embodiment of the present disclosure will now be described. In the first embodiment, whether to attach a serial number is determined based on the redundancy of the candidate filenames of the divided files. The second embodiment deals with a case where a file naming rule setting screen includes a setting item for attaching serial numbers to filenames, and serial numbers are assigned to divided files regardless of whether the candidate filenames are redundant. A configuration of the second embodiment is similar to that described in the first embodiment except for the procedure for generating a filename, illustrated in FIG. 13.

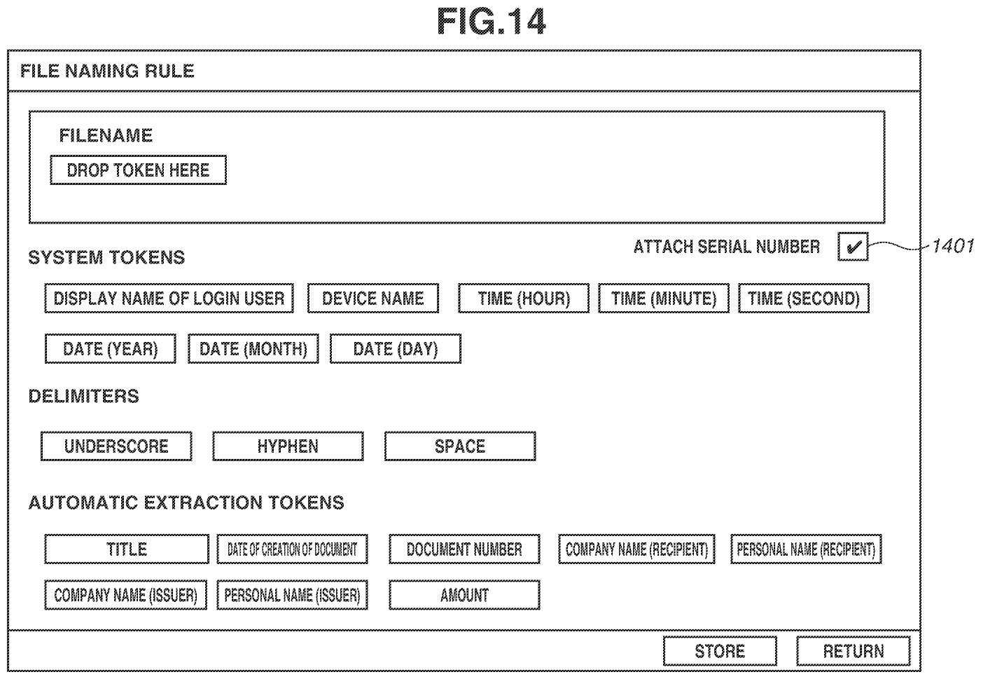

FIG. 14 illustrates another example of the file naming rule setting screen 700 illustrated in FIG. 7. The file naming rule setting screen includes an “attach serial number” checkbox 1401 in addition to the setting items described in FIG. 7. If the “attach serial number” checkbox 1401 is on, serial numbers are attached to the ends of the candidate filenames of divided files regardless of whether the candidate filenames are redundant.

For example, if there are five divided files, serial numbers “_1” to “_5” are attached to the ends of the candidate filenames of the respective divided files. Specific processing will be described with reference to FIG. 13B. The operation in step S1301 is similar to that of step S1301 in FIG. 13A. In step S1311, the image processing unit 424 determines whether the “attach serial number” checkbox 1401 is on. If the “attach serial number” checkbox 1401 is on (YES in step S1311), the processing proceeds to step S1312.

In step S1312, the image processing unit 424 attaches a serial number to the end of the candidate filename generated in step S1301. The filename generation processing is repeated as many times as the number of divided files. In step S1312, a serial number “_1” is attached to the first file. Serial numbers incremented by one are attached to the second and subsequent files upon each repetition.

If there are five divided files, serial numbers “_2” to “_5” may be attached to the ends of the filenames of the second and subsequent divided files.

In step S1311, if the image processing unit 424 determines that the “attach serial number” checkbox 1401 is determined to be off (NO in step S1311), the processing proceeds to step S1313. Here, the image processing unit 424 performs the filename generation processing without attaching a serial number to the candidate filename of any of the divided files. Specifically, in step S1313, the image processing unit 424 determines the candidate filename generated in step S1301 as the filename.

In the present embodiment, a candidate filename is generated based on the file naming rule before the setting of the “attach serial number” checkbox 1401 is consulted to determine whether to attach a serial number. However, the processing order is not limited thereto. The setting of the “attach serial number” checkbox 1401 may be consulted first. If the setting is on, a filename with a serial number is generated based on the file naming rule. If the setting is off, a filename without a serial number is generated based on the file naming rule.

As described above, the provision of the setting item for attaching serial numbers to filenames on the file naming rule setting screen enables switching whether to attach serial numbers depending on the setting.

In the present embodiment, if, in step S1311, the “attach serial number” checkbox 1401 is off, then the filename to be determined in step S1313 can be redundant with that of one of the divided files. In other words, some of the filenames displayed on the scanned file list screen 1100 can be redundant. In such a case, the user can edit the filenames by selecting a file to edit the filename of and pressing the edit button 1103. Alternatively, if the image processing unit 424 detects that the user selects one of the files displayed on the scanned file list screen 1100 and presses the transmission button 1102, the image processing unit 424 transmits the file to the storage server 130. In transmitting the selected file to the storage server 130, the image processing unit 424 checks the filenames of the files in the transmission destination folder of the storage server 130. If the filename of the file to be transmitted is redundant with that of a file stored in the folder, the image processing unit 424 attaches a serial number.

A third embodiment of the present disclosure will be described below. In the first embodiment, whether to attach a serial number is determined based on the redundancy of the filenames of the divided files. The third embodiment deals with a case where a serial number token is provided in a token area of the file naming rule setting screen.

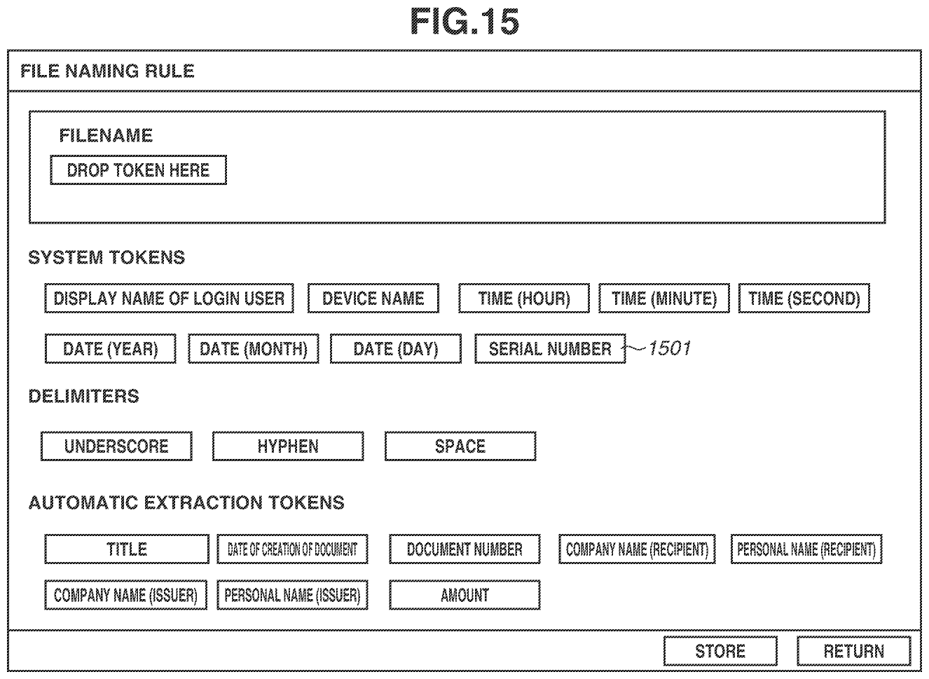

FIG. 15 illustrates another example of the file naming rule setting screen 700 illustrated in FIG. 7. In addition to the settings described with reference to FIG. 7, a “serial number” token 1501 is provided in the system token area. The setting method is similar to that of the other system tokens described in the first embodiment, and a “serial number” can be specified at a given position of the filename as a file naming rule. If the “serial number” token 1501 is set in the file naming rule, serial numbers are attached to the filenames of the divided files at the position set by the file naming rule.

An example of the file naming rule is as follows:
<Setting Content of File Naming Rule>
“'serial number' ‘underscore (delimiter token)’ ‘company name (issuer) (automatic extraction token)’ ‘underscore (delimiter token)’ ‘date of creation of document (automatic extraction token)’”.
If there are five divided files, serial numbers “2” to “5” are attached to the beginning of the filenames of the second and subsequent divided files. Alternatively, serial numbers “1” to “5” are attached to the beginning of the filenames of the respective divided files.

As in the first and second embodiment, the processing illustrated in FIG. 12 is performed as the processing for generating a filename. The filename generation processing performed in step S1206 is different from those in the first and second embodiments. The processing for generating a candidate filename using the file naming rule and character strings in step S1301 is similarly performed in the present embodiment. The generated candidate filename is then determined to be the filename.

As described above, the provision of the serial number token 1501 in a token area of the file naming rule setting screen enables the user to set a file naming rule including whether to attach a serial number and which position to attach the serial number to. Serial numbers can thus be appropriately attached based on the settings.

### <Other Exemplary Embodiments>

An embodiment of the present disclosure can be implemented by processing for supplying a program for implementing one or more functions of the foregoing embodiments to a system or an apparatus via a network or a storage medium, and reading and executing the program by one or more processors in a computer of the system or apparatus. A circuit for implementing one or more functions (e.g., application-specific integrated circuit [ASIC] or field-programmable gate array [FPGA]) can also be used for implementation.

An information processing apparatus according to an embodiment of the present disclosure is able to generate, in generating a plurality of files from image data obtained by a single scan, filenames in consideration of a condition under which the filenames of the respective files are numbered.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of priority from Japanese Patent Application No. 2023-018181, filed Feb. 9, 2023, which is hereby incorporated by reference herein in its entirety.

What is claimed is:

1. An information processing apparatus comprising:
at least one memory configured to store instructions; and
at least one processor communicatively connected to the at least one memory and configured to execute the stored instructions to:
obtain image data by a single scan;
analyze the image data to extract a character string;
generate a plurality of files from the image data;
automatically generate a filename of each of the plurality of files using a character string extracted from the image data included in a corresponding file of the plurality of files; and
in a case where at least two generated filenames among the generated filenames of the plurality of files are the same, add an identifier and determine filenames so that the at least two same filenames are distinguished.

2. The information processing apparatus according to claim 1, wherein each of the plurality of files is transmitted to an external server.

3. The information processing apparatus according to claim 2, wherein, in a case where a file, among the plurality of files to be transmitted, has a same filename as that of a file stored in a predetermined folder of the external server, an identifier, to distinguish the filename of the file to be transmitted, is added to the filename and the file to be transmitted is transmitted to the external server.

4. The information processing apparatus according to claim 1, further configured to:
accept a setting of an item corresponding to the character string to be used for the filename to be automatically generated; and
automatically generate the filename of each of the plurality of files using the character string corresponding to the item.

5. The information processing apparatus according to claim 4, wherein the item includes information corresponding to the identifier to distinguish the filename.

6. The information processing apparatus according to claim 1, further configured to communicate with an image processing apparatus including a scanner,
wherein the image data is obtained by the scanner of the image processing apparatus scanning a plurality of documents at a time.

7. A method for controlling an information processing apparatus, the method comprising:
obtaining image data by a single scan;
analyzing the image data to extract a character string;
generating a plurality of files from the image data;
automatically generating a filename of each of the plurality of files using a character string extracted from the image data included in a corresponding file of the plurality of files; and
in a case where at least two generated filenames among the generated filenames of the plurality of files are the same, adding an identifier and determine filenames so that the at least two same filenames are distinguished.

8. A non-transitory computer-readable storage medium storing a computer program for causing the computer to perform a method for controlling an information processing apparatus, the method comprising:
obtaining image data by a single scan;
analyzing the image data to extract a character string;
generating a plurality of files from the image data;
automatically generating a filename of each of the plurality of files using a character string extracted from the image data included in a corresponding file of the plurality of files; and
in a case where at least two generated filenames among the generated filenames of the plurality of files are the same, adding an identifier and determine filenames so that the at least two same filenames are distinguished.
